(19) United States
(12) Patent Application Publication
(10) Pub. No.: US 2003/0138082 A1
(43) Pub. Date: Jul. 24, 2003

(54) Line interface for combining a voice band signal and an XDSL signal on a twisted-pair copper line

(76) Inventors: Ferdinando Lari, Vimercate (IT); Daniele Devecchi, Desio (IT); Emanuela Vizzi, Milano (IT)

Correspondence Address: Bryan A. Santarelli/KDJ, Graybeal Jackson Haley LLP, 155-108th Avenue NE, Suite 350, Bellevue, WA, 98004, US

(21) Appl. No.: 10/316,967

(22) Filed: Dec. 10, 2002

(30) Foreign Application Priority Data
Dec. 10, 2001 (EP) 01830754.6

(51) Int. Cl. H04M 11/00

(52) U.S. Cl. 379/93.01; 379/93.06

(57) ABSTRACT

A line interface for combining a broad-band XDSL signal and a voice-band telephone signal in a copper duplex cable, where the voice-band signal, over and above the voice signal, carries a DC feed for the user telephone and, during the call phase, also a ring signal. The XDSL signal and the voice signal are coupled to at least one primary winding of a line transformer of which the secondary winding pilots the telephone duplex cable. The secondary winding is not DC-coupled with the duplex cable and the ring and feed signals are injected into the duplex cable by a circuit realized in high-voltage technology and arranged in parallel with the secondary winding. A further inductive winding performs the function of compensating the flow variations induced in the core of the line transformer during the call phase.

### CROSS-REFERENCE TO RELATED APPLICATION

The present application claims priority from European patent application No. 01830754.6, filed Dec. 10, 2001, which is incorporated by reference.

### TECHNICAL FIELD

The present invention concerns access networks for advanced telecommunication services and, more particularly, a line interface for combining telephony and XDSL signals on the same twisted-pair copper line.

### BACKGROUND OF THE INVENTION

The growing demand for residential broad-band communication services has led to the development of technologies that utilize the twisted-pair copper line traditionally employed for telephone services as the physical support for accessing the service provider networks.

These technologies, generally known as XDSL (X Digital Subscriber Loop) systems, have affirmed themselves in recent years on account of being economically more advantageous than other solutions that call for the installation of such new and costly infrastructures such as, for example, microwave access networks (LMDS being a case in point) or optical fiber networks.

A technology that has particularly affirmed itself within the ambit of the variegated family of the XDSL systems is the one known as ADSL (Asymmetric Digital Subscriber Loop), a technology that, in a very efficient manner, offers transmission services for which the data flow received by the user is greater than the one he directs towards the network.

The ADSL coexists with traditional telephony (or voice) services and utilizes portions of the transmission band of the copper line not superposed on the frequencies employed for telephony.

In this way, differently from what happens in the case of modems operating in the voice band, telephone communications can be effected even while a data transmission (a connection to Internet, for example) is taking place.

The voice services (complete with the associated signaling) utilize the 0-16 kHz band of the twisted-pair, copper line, while the ADSL uses the range of frequencies comprised between 30 kHz and 1.1 MHz, transmitting with a multi-carrier DMT (Discrete Multi Tone) modulation.

The ADSL subdivides the available frequency spectrum into two bands, the first (from 30 kHz to 138 kHz) for the data flow from the user towards the network (upstream path), the second (from 138 kHz to 1.1 MHz) for the data flow in the opposite direction (downstream path).

The architecture of an ADSL access network is shown in FIG. 1. The central-office electronic equipment and circuits for the transmission and reception of the ADSL signals are contained in racks 1, known as DSLAM (Digital Subscriber Line Access Multiplexers), that are generally situated in the vicinity of the PSTN (Public Switched Telephonic Network) telephone exchanges 2.

The multiplexer racks 1 constitute the node for accessing high-capacity, service provider network 3, the so-called Backbone Network.

Each ADSL signal generated by a central-office modem 4, generally referred to as ATU-C (ADSL Terminal Unit—Central Office), is coupled by means of a POTS splitter 5 to a twisted-pair cable 6 traditionally used for the transmission of telephone signals.

Just as in the case of telephone equipment, the transmission flow of the central-office ADSL equipment is bidirectional: the central-office POTS splitter 5 functions as a coupler in one direction and as a splitter in the other.

Another POTS splitter 7 at the user end, bi-directionally couples the copper cable 6 to both the user modem 8, generally referred to as ATU-R (ADSL Terminal Unit—Remote), and a traditional telephone apparatus 9. This is done in an architecture 10, the so-called full-rate ADSL, capable of ensuring maximum transmission capacity.

There are also other solutions, likewise shown in FIG. 1, commonly employed for the user-side terminations. The terminations 11 (ADSL G.Lite) and 12 (ADSL non-standard), for example, do not employ POTS splitters, which are replaced by less voluminous, easy to install, and cheaper filters (microfilters 13 or, in-line filters 14). Though these terminations 11 and 12 provide a somewhat smaller transmission capacity then full-rate ADSL, they are, nevertheless, capable of offering residential services in line with effective present-day needs.

The POTS splitter 5, which typically couples voice and data flows and also typically sustains signals of very substantial amplitude in either direct current or very low frequency AC, is realized in high-voltage technology. Superposed on the voice signal, in fact, there is present the DC feed signal (50/60 V) of the telephone apparatus and, during the actual calling phase, also a low-frequency ringer signal (up to 110 V rms).

When realized in conformity with high-voltage technology, a splitter with good linearity characteristics, as is typically required for ADSL purposes, is necessarily a costly and rather voluminous device.

Numerous solutions have been proposed with a view to eliminating the splitters, especially the one installed in the vicinity of the central office, because, as has already been suggested, valid alternatives are already available for the user-side terminations.

Another reason for eliminating the splitter 5 is that, for the service operators, it is a fundamental requirement to reduce the space occupied by the central-office equipment to a bare minimum, because the cost of this space is very considerable.

In the most recently introduced access solutions, the physical separation between the central-office equipment, handling voice signals and their counterparts for data signals is no longer very neat, and the present trend is to integrate everything on a single circuit board, thus facilitating the elimination of the POTS splitters.

Referring to FIG. 2 and considering the transmission direction, i.e. from the central-office to the user, a central office circuit board 20 integrating the circuits for voice and data signals is used to sum the telephone signals 21 and 22 with the data signals 23 upstream of the line interface 24. The final stage of this interface is a wide-band amplifier 25, or line driver, that drives the line 26 and is realized in high-voltage technology.

Although this solution avoids the use of a splitters (FIG. 1) on the central office side, it has a considerable drawback in that the excessive power dissipated by the arrangement and, more particularly, the line driver 25 is excessive.

The output dynamic range of this amplifier 25 is typically very high, because the amplifier 25 will typically be required to transmit to the twisted-pair copper line 26 the sum of the DC telephone feed signal 21 (50 V DC), the ringer signal 21 (in this type of board typically 60 V rms), the voice signal and the high-frequency data signal 21 (in the case of ADSL 18/20 V peak).

Consequently, the circuit board 20 for integrated voice and data services has to be provided with a considerable feed voltage, typically not less than 85-90 Volts. In these conditions, the overall power dissipation will typically be significantly greater as compared with a solution in which the final line interface stages are separated and optimized for the different signal types (voice/data) and which, for this very reason, can make do with smaller feed voltages.

### SUMMARY OF THE INVENTION

An embodiment of the present invention, therefore, sets out to propose a solution in which the voice and data transmission components are integrated on one and the same circuit board and which does not give rise to the drawbacks associated with the prior art as described above.

### BRIEF DESCRIPTION OF THE DRAWINGS

The invention will be understood more clearly in the light of the detailed description of a particular embodiment thereof given below, which is to be considered as an example and not limitative in any way, said description making reference to the attached drawings of which:

FIG. 1 shows the architecture of a traditional ADSL access system,

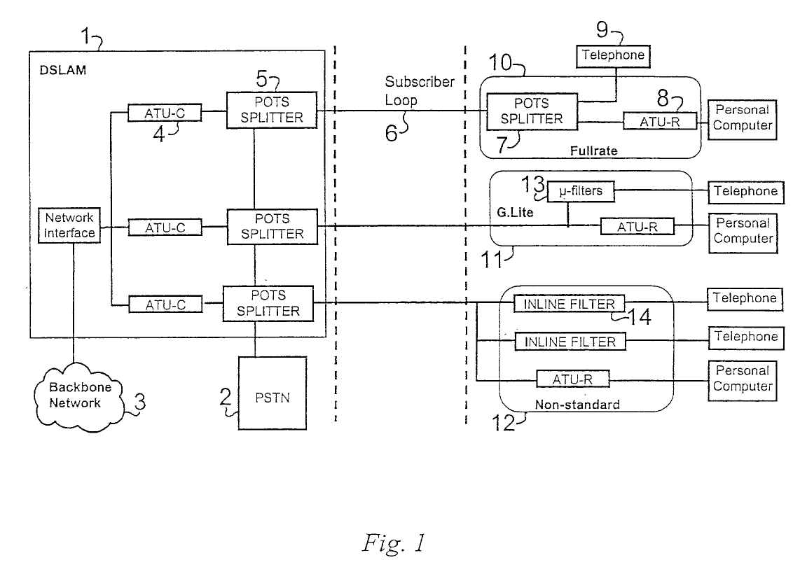

FIG. 2 shows, albeit schematically, a circuit board for integrated voice/data services according the prior art, and

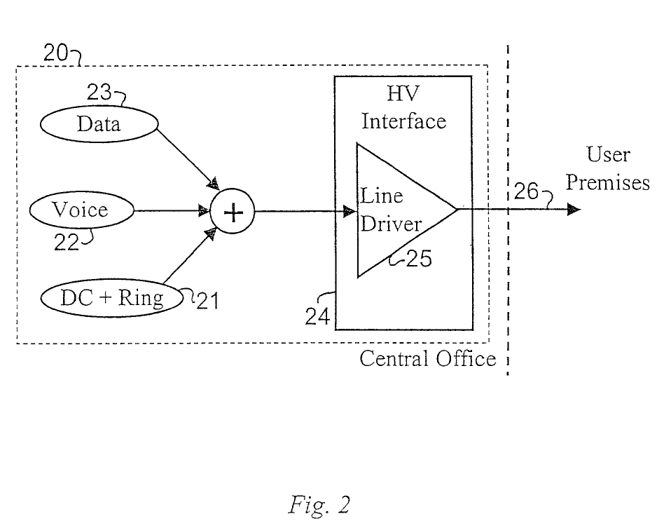

FIG. 3 shows the layout of a circuit board for integrated voice/data services that employs a line interface in accordance with an embodiment of the invention.

### DETAILED DESCRIPTION

The following discussion is presented to enable a person skilled in the art to make and use the invention. The general principles described herein may be applied to embodiments and applications other than those detailed below without departing from the spirit and scope of the present invention. The present invention is not intended to be limited to the embodiments shown, but is to be accorded the widest scope consistent with the principles and features disclosed or suggested herein.

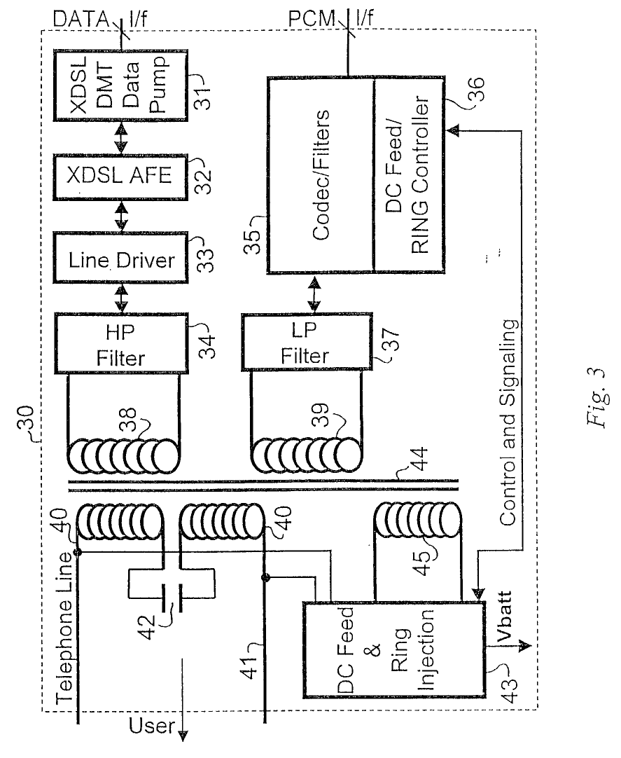

As can be seen from FIG. 3 in a preferred embodiment of the present invention, the traditional telephone service circuitry is integrated on the circuit board 30, which accommodates the circuits handling the XDSL signals. In particular, in the upper part of the board 30, in the transmission direction from the central office to the user, the digital XDSL signal, synthesized by the block 31 (XDSL DMT Data Pump), is converted into an analog signal by the block 32 (XDSL AFE, Analog Front End) and subsequently amplified by the line driver 33, which is optimized for the transmission of XDSL signals.

A high-pass filter 34 on the output side of line driver 33 eliminates any spurious low-frequency noise that might be present and could constitute a troublesome interference source for the telephony signals.

In the lower part of the board 30, still considering the transmission direction from the central office to the user, a PCM telephone signal is processed by the block 35 (Codec/Filters), which is analogous to what happens in a traditional solution for telephony only. The sole difference with respect to prior art consists of the fact that the block 35 includes a control section 36 (DC Feed/Ring Controller). The telephone signal is then processed by a low-pass filter 37, which is not affected by DC components.

The filters 34 and 37 drive, respectively, two primary windings 38 and 39 of a line transformer of which the secondary winding 40, in turn, drives the telephone line 41. An important characteristic of this embodiment of the present invention is the fact that the secondary winding 40 of the line transformer is AC coupled to the twisted-pair cable 41. This is obtained, for example, by inserting a decoupling condenser 42 in series with the secondary winding 40, interrupting the secondary winding 40 at some intermediate point. However, the configuration shown in FIG. 3 is not binding and the capacitance 42 can be inserted at any other point, always provided that it remains in series with the secondary winding 40.

In this way, the line transformer, not being affected by DC components, can be realized very simply and cheaply and will also be small in size.

In FIG. 3, and solely by way of example, the data and voice signals are coupled to two distinct primary windings 38 and 39, respectively. In a different embodiment, however, the data and voice signals could be summed at any other point before the line transformer and coupled inductively to the secondary winding 40 via a single primary winding 38 or 39.

The functions of providing the DC feed for the user telephones and injecting the ring signal into the copper line 41 are realized by an interface circuit in high-voltage technology, which in FIG. 3 is represented by the block 43 (DC Feed & Ring Injection), which is connected in parallel to the secondary winding 40 of the line transformer.

Block 43 operates under the control and management of the DC Feed/Ring Controller 36.

Even though the capacitance 42 in series with the two secondary windings 40 is capable of insulating the secondary winding 40 from direct current components, it does not completely insulate the core 44 of the transformer from interference due to the injection of the ring signal (16-60 Hz) during the call phase. This happens because the capacitor 42 is designed in such a way as to pass the low-frequency components of the voice signal (20 Hz).

The interference due to the ring signal causes the working point of the magnetic characteristics of the transformer core 44 to become displaced, thus giving rise to possible non-linear conditions.

This effect exerts a negative influence on the performance of the ADSL transmission, which employs QAM signals of high spectral efficiency (up to 8096 QAM) and is, therefore, very sensitive both to intermodulation and module and phase variations, so that it calls for conditions of absolute linearity throughout the transmission chain.

For this reason, a compensation winding 45 is provided for the purpose of eliminating or reducing any flow variations in the transformer core 44 that may be induced by the injection of the ring signal.

This effect may be obtained, for example, by injecting a duplication of the ring signal with an appropriately calibrated amplitude and phase into the compensation winding 45 via the block 43 during the call phase. This signal can set up a counterflow in the core of the line transformer to cancel or attenuate the undesired flow induced by the ring signal.

In this embodiment, the block that sums the ring signal also performs the function of compensating the negative effect produced by this signal; this fact simplifies the phase of setting and calibrating the circuit board and also renders it more accurate.

The injection of the compensation signal is effected only during the call phase, i.e. when all the digital signal processing (DSP) blocks are inactive. For this reason, no additional hardware resources have to be provided for performing this function.

Furthermore, the proposed solution effects the compensation without altering the configuration of the interface from the circuit point of view. This makes it possible to avoid varying the impedance at the terminals of each winding and to keep the line impedance matching constant in time, a requirement that is typically indispensable for assuring the continuity and quality of the XDSL connection.

1. A line interface for combining a broad-band XDSL signal and a voice-band telephone signal in a twisted-pair copper line, where the voice-band signal, over and above the voice signal, carries a DC feed for the user telephone and, during the call phase, also a ring signal, the XDSL signal and the voice signal being coupled to at least one primary winding of a line transformer of which at least one secondary winding pilots the twisted-pair telephone line, characterized in that said secondary winding is DC decoupled from said telephone line and the ring signals and the feed signals are injected into said line by a circuit arranged in parallel with said secondary winding.

2. A line interface in accordance with claim 1, wherein the DC decoupling of the secondary winding of the line transformer is obtained by means of capacitive decoupling means arranged in series with said secondary winding.

3. A line interface in accordance with claim 1, wherein the capacitive decoupling means comprise at least one capacitor series-connected with the secondary winding in such a manner as to interrupt it at some intermediate point.

4. A line interface in accordance with claim 1, wherein the line transformer comprises at least one further winding to compensate flow variations induced in the core of the line transformer by the ring signal during the call phase.

5. A line interface in accordance with claim 4, wherein the circuit injects the same ring signal into the compensation winding (45) during the call phase as is injected into the twisted-pair copper line (41), with amplitude and phase adjusted in such a manners as to eliminate or reduce the flow variations induced in the core (44) of the line transformer.

6. A line interface in accordance with claim 1, wherein the XDSL signal is filtered by at least one high-pass or band-pass filter (24) coupled to the primary winding of the line transformer.

7. A line interface in accordance with claim 1, wherein the voice signal is filtered by at least one low-pass filter coupled to the primary winding of the line transformer.

8. A line interface in accordance with claim 1, wherein the XDSL signal and the voice signal are coupled to at least two distinct primary windings (38, 39) of the line transformer.

9. An interface for driving an XDSL signal and a telephone signal onto a twisted pair, the interface comprising:
first and second terminals operable to be coupled to the twisted pair;
a transformer having a first winding operable to be AC coupled to the first and second terminals pair and having a second winding;
an XDSL terminal operable to receive the XDSL signal and coupled to the second winding of the transformer; and
a telephone terminal operable to receive the telephone signal and coupled to the second winding of the transformer.

10. The interface of claim 9, further comprising a capacitor in series with the second winding.

11. The interface of claim 10 wherein the capacitor is serially coupled between two portions of the second winding, the two portions having substantially the same length.

12. The interface of claim 9, further comprising a ring-signal generator coupled to the first and second terminals.

13. The interface of claim 9, further comprising a telephone-feed-signal generator coupled to the first and second terminals.

14. The interface of claim 9, further comprising a ring-signal-compensation generator coupled to the second winding of the transformer.

15. The interface of claim 9, further comprising a filter coupled between the XDSL terminal and the second winding, the filter operable to filter out undesirable low-frequency signals from the XDSL signal.

16. The interface of claim 9, further comprising a filter coupled between the telephone terminal and the second winding, the filter operable to filter out undesirable high-frequency signals from the telephone signal.

17. The interface of claim 9, further comprising a synthesizer circuit coupled between the XDSL line and the first primary winding of the transformer core, the synthesizer operable to synthesize the XDSL signal.

18. The interface of claim 9, further comprising a digital-to-analog converter circuit coupled between the XDSL terminal and the second winding of the transformer, the digital-to-analog converter circuit operable to convert the XDSL signal from digital to analog.

19. The interface of claim 9, further comprising a line-driver circuit coupled between the XDSL terminal and the second winding of the transformer, the line-driver circuit operable to amplify the XDSL signal.

20. The interface of claim 9, further comprising a processing circuit coupled between the telephone terminal and the second winding of the transformer, the processing circuit operable to inject a ring compensation signal into the transformer during a call phase.

21. An interface for driving an XDSL signal and a telephone signal onto a twisted pair, the interface comprising:
first and second terminals operable to be coupled to the twisted pair;
a transformer having a first winding operable to be AC coupled to the first and second terminals pair, a second winding, and a third winding;
an XDSL terminal operable to receive the XDSL signal and coupled to the second winding of the transformer; and
a telephone terminal operable to receive the telephone signal and coupled to the third winding of the transformer.

22. A method, comprising:
AC coupling an XDSL signal to a line; and
simultaneously AC coupling a telephone signal to the line.

23. The method of claim 22, further comprising:
DC coupling a ring signal to the line during a call phase; and
AC coupling a ring-compensation signal to the line during the call phase.

24. The method of claim 23 wherein AC coupling the ring-compensation signal comprises coupling the ring-compensation signal to the line at the initiation of a ring-controller circuit operable to detect the call phase.

25. The method of claim 22, further comprising DC coupling a telephone power signal to the line.
